(19) United States
(12) Patent Application Publication
(10) Pub. No.: US 2005/0267867 A1
(43) Pub. Date: Dec. 1, 2005

(54) Auto-display architecture for storage device and method thereof

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/094,131

(22) Filed: Mar. 31, 2005

(30) Foreign Application Priority Data
May 28, 2004 (TW) 093115440

(51) Int. Cl. G06F 17/30

(52) U.S. Cl. 707/2

(57) ABSTRACT

An auto-display architecture for storage device and method thereof are disclosed. A computer system installed with a first operating system and a second operating system is initiated under the second operating system. When an end user provides a piece of information to a storage device, a detecting unit automatically compares the information format with data format recorded in an index table so as to find a display unit corresponding to the information format. The detecting unit is installed on the second operating system or the first operating system. If the display unit is installed in the first operating system, then through the conversion of an interface unit, the display unit is converted into executable format of the second operating system so as to display the data stored inside the storage device.

### BACKGROUND OF THE INVENTION

The present invention relates to an auto-display architecture for storage device and method thereof, especially to an architecture and method that automatically detect information in an external storage device for displaying.

In recent years, along with rising of living standards and fast food like life style, people get used to fast and convenient lives. The development of intelligent technology also has a trend to make the computer have higher efficiency for matching user requirements. Computer systems nowadays are multi-functional. People spend their leisure time on computers and Internet. The most common entertainment is to watch video data and listen to the audio data.

In earlier days, computers can only display audio information in storage devices provided by end users automatically. When people want to watch video information, they need to initiate application programs for retrieving video data inside an optical disk drive and displaying. However, such way is no more enough for matching user needs.

In order to simplify the complicated operation procedures in users' end, the Microsoft operating system-Windows XP has an auto-play list feature. When an end user provides some video data inside the storage devices, the operating system displays them automatically with Windows Media Player.

Although the Windows XP has a feature of auto-play list, such operating system has higher system resource consumption, compared to the Linux operating system. Thus it takes longer time to turn on the computer system when an end user wants to display information inside the storage device automatically. Moreover, in order to avoid repeated installation for saving system resources, it is a point to make the computer system with Linux operating system shares resources with the computer system with Windows operating system.

Due to the improvement of information technology, except the auto-display technique of audio and video information available now, a lot more auto-display techniques for other digital information such as image files are going to be development in future Therefore, there is a need to provide an auto-display architecture for storage device and method thereof by which the operating system with lower resource consumption shares application programs with the operating system having higher resource consumption so as to avoid the repeated installation of application programs in two operating systems, save the storage space and reduce waiting time for turning on the computer system.

### SUMMARY OF THE INVENTION

It is a primary object of the present invention to provide an auto-display architecture for storage device and method thereof. The computer system is installed with a first operating system having higher system resource consumption and a second operating system having lower system resource consumption. The auto-display architecture automatically detects stored information for displaying under the second operating system. By a detecting unit, the data format of information stored in a storage device is detected and compared with the information format recorded inside an index table so as to find out a display unit corresponding to the stored information. Then the display unit is run to display the stored information.

It is another object of the present invention to provide an auto-display architecture for storage device and method thereof that automatically displays information inside the storage device without complicated operation procedures in user-end. By an input unit, which is a remote controller, a command is sent to turn on the computer system. After being booted, an end user provides a piece of information into the storage device, the computer system automatically detects information format of the information stored inside the storage device and further uses a corresponding display unit to display the stored information.

It is a further object of the present invention to provide an auto-display architecture for storage device and method thereof that meets requirement of end users. According to users' needs of display unit, an editing command of the index table is sent from the central processing unit to an editing unit so that the editing unit is able to change the display unit according to the information format recorded in the index table.

It is a further object of the present invention to provide an auto-display architecture for storage device and method thereof for saving storage space. By the second operating system shares the detecting unit and the display unit of the first operating system with the first operating system, the storage space is saved effectively.

It is a further object of the present invention to provide an auto-display architecture for storage device and method thereof that saves power consumption. After initiating a second operating system with lower resource consumption, only system resource related to the detecting unit as well as the display unit is used so that the system resource is saved effectively.

In order to achieve above objects, the present invention provides an auto-display architecture for storage device and method thereof. A computer system installed with a first operating system and a second operating system is initiated under the second operating system. When an end user provides a piece of information into a storage device, a disk controller of the storage device sends an interrupt signal to a central processing unit immediately. Then the central processing unit instructs the second operating system to display the information. A detecting unit is installed on the second operating system or the first operating system. When the detecting unit is executed under the first operating system, then through the conversion of an interface unit, the detecting unit is converted into executable format of the second operating system. By the detecting unit, the information format of the stored information is compared with the information format recorded in an index table so as to get the display unit corresponding to the stored information. When the display unit is installed under the first operating system, through the conversion of an interface unit, the display unit is converted into executable format of the second operating system so as to display the data stored inside the storage device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment in accordance with the present invention that shares an index table;

FIG. 2 is a block diagram of another embodiment in accordance with the present invention that shares system resource of the first operating system;

FIG. 3 is a schematic drawing showing structure of PC bus of an embodiment in accordance with the present invention;

FIG. 4 is a block diagram of an auto-display architecture of an embodiment in accordance with the present invention;

FIG. 5 is a schematic drawing of an index table of an embodiment in accordance with the present invention;

FIG. 6 is a block diagram of an editing unit of an embodiment in accordance with the present invention;

FIG. 7 is a flow chart of an embodiment in accordance with the present invention.

### DETAILED DESCRIPTION OF THE PREFFERED EMBODIMENT

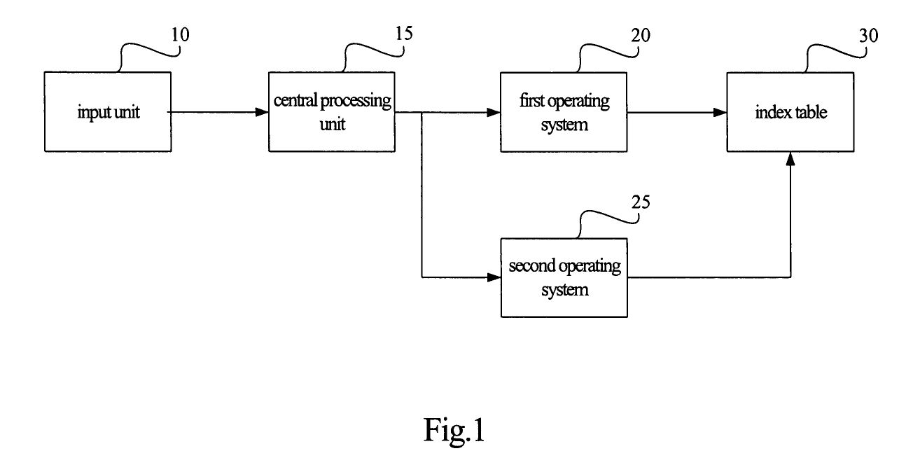

Refer to FIG. 1, an embodiment in accordance with the present invention having a first operating system 20 with higher system resource consumption and a second operating system 25 with lower system resource consumption provides an index table 30 in a file system of the first operating system 20 for recoding at least one display unit corresponding to some information format. An end user sends a command to a central processing unit 15 through an input unit 10 for initiating the second operating system 25 that shares information in the index table 30 of the first operating system 20 with the first operating system 20.

When an end user installs at least one application program, the index table 30 records the information format supported by the application program.

The first operating system 20 is a FAT or a NTFS file format installed in a larger storage space such as a hard disk or a read only memory device while the hard disk is a main storage device. The first operating system 20 is a Windows operating system such as Windows XP, Windows NT, Window 98, Windows 2000 and Windows Me.

The second operating system 25 is a EXT2 or a EXT3 file format installed in a smaller storage space such as a hard disk, read only memory (ROM) or an external storage device such as a hard disk with Universal Serial Bus (USB) interface. The hard disk with Universal Serial Bus interface with convenience and portability is the main storage device. The second operating system 25 is able to be applied on each computer with a USB slot. The second operating system 25 is a Linux operating system.

The input unit 10 is a remote controller or a keyboard.

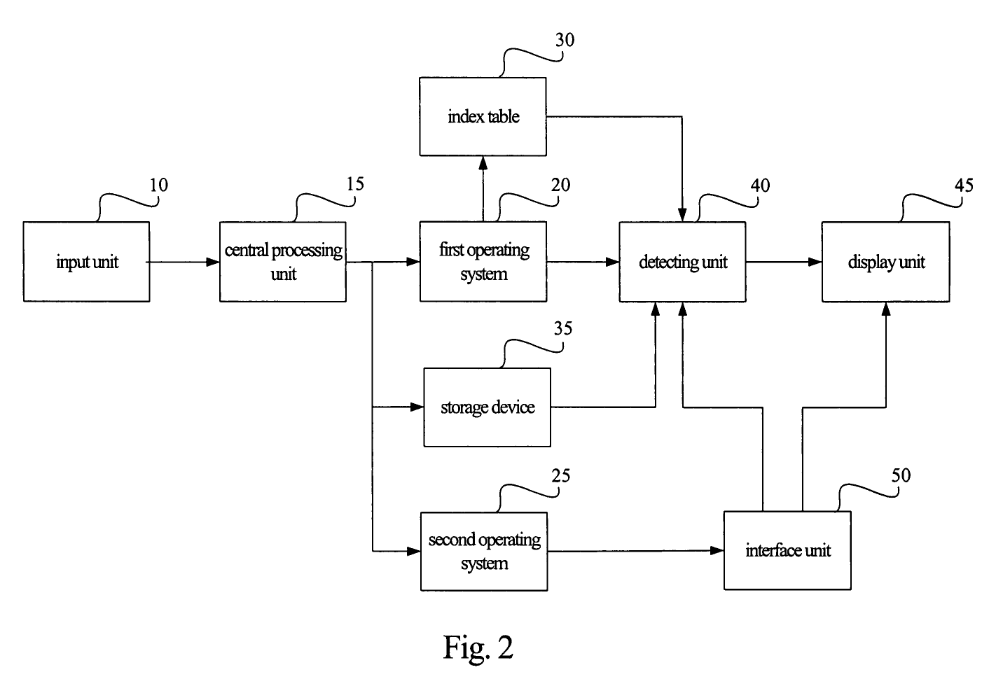

Refer to FIG. 2, an end user inputs a switch-on command to a central processing unit 15 through an input unit 10. The computer is turned on by a basic input/output system and is booted into the second operating system 25. Then the stored data is detected under the second operating system 25 and displayed automatically under the second operating system 25. When an end user provides a piece of information into a storage device 35, the second operating system 25 converts a detecting unit 40 of the first operating system 20 into executable format of the second operating system 25 through an interface unit 50. The data format stored in the storage device 35 is compared with that inside the index table 30 automatically by the detecting unit 40. According to the result of comparison, if a display unit 45 corresponding to the data format of the stored information recorded by the index table 30 is executed under the first operating system 20, the second operating system 25 converts the display unit 45 through the interface unit 50 for displaying the stored information inside the storage device 35 automatically. By sharing resource with the first operating system 20, the initiating time of the first operating system 20 with higher resource consumption and larger storage space is reduced, the repeated installation of application programs is avoided and the storage space is saved effectively.

The computer system automatically detects the information stored inside the storage device 35 and uses the data recorded in the index table 30 to find out the display unit 45 corresponding to the data format of the stored information for displaying. Thus there is no need for users to run complicated operation procedures for displaying the information inside the storage device 35.

The storage device 35 mentioned above is a storage device with IDE(Integrated Device Electronics) interface, a storage device with SCSI(Small Computer System Interface) interface, or other storage device such as a hard disk with USB interface.

The information stored inside the storage device 35 is an audio data, video data, text information, or other information such as image data.

The interface unit 50 is for the conversion of the detecting unit 40 as well as the display unit 45 between the first operating system 20 and the second operating system 25 so as to make the detecting unit 40 and the display unit 45 be converted into executable format of the second operating system 25.

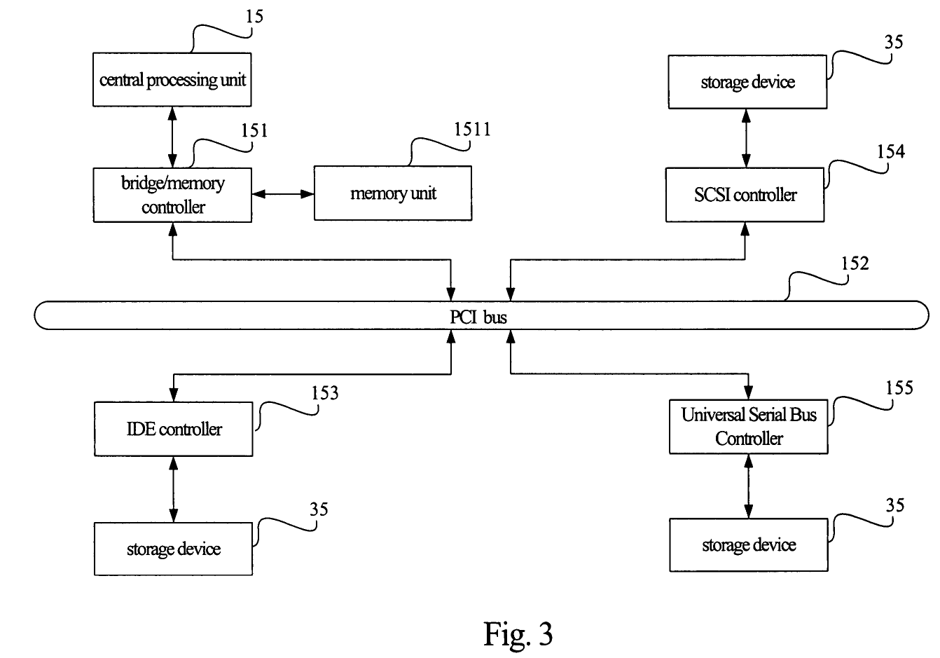

Refer to FIG. 3, the central processing unit 15 is connected with at least one disk control unit that consists of a bridge/memory controller 151, a PCI(Peripheral Component Interconnect) bus 152, a IDE(Integrated Device Electronics) controller 153, a SCSI(Small Computer System Interface) controller 154 and a Universal Serial Bus Controller 155 while the IDE controller 153, the SCSI controller 154 and the Universal Serial Bus Controller 155 provide at least one register for temporarily data storage.

When the end user provides a piece of information to the storage device 35 connected with the IDE controller 153, the IDE controller 153 retrieves information inside the storage device 35 into the register thereof or transmits the information inside the storage device 35 into a memory unit 1511 of the bridge/memory controller 151 and sends an interrupt signal to the central processing unit 15. After receiving the interrupt signal, the central processing unit 15 automatically detects information format of information inside the register of the IDE controller 153 or the memory unit 1511 by the detecting unit 40. Then a display unit 45, corresponding to the information format of the stored information recorded by the index table, is provided to display the information inside the storage device 35 automatically. As previous procedures, the SCSI controller 154 and the Universal Serial Bus Controller 155 are activated in similar way of the IDE controller 153.

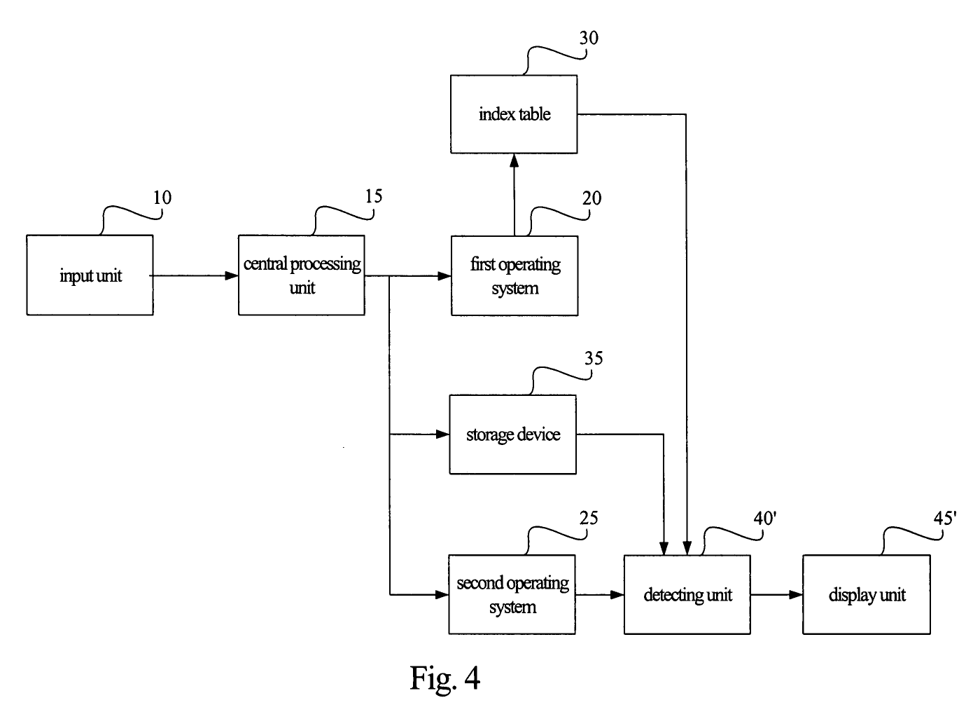

Refer to FIG. 4, a detecting unit 40′ and a display unit 45′ corresponding to information format of the information that is stored inside the storage device 35 and recorded by the index table 30, are installed in the second operating system 25. According to the comparison result between the information format of the information stored inside the storage device 35 and that of the index table 30, the second operating system 25 executes the display unit 45′ recorded inside the index table 30 so as to display the information stored in the storage device 35.

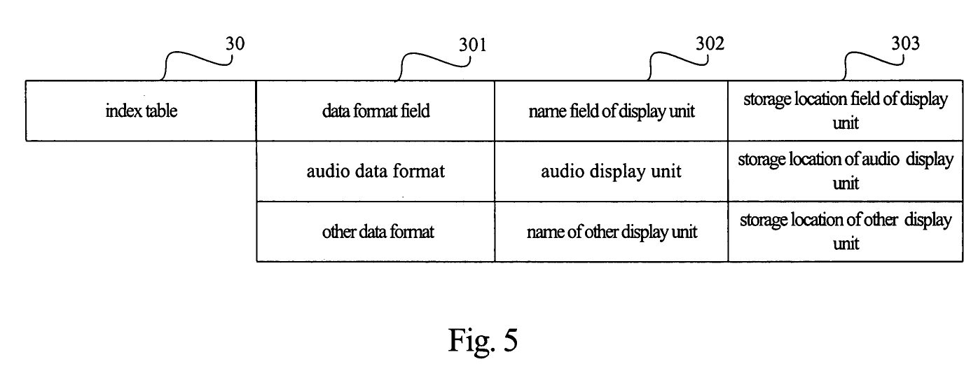

Refer to FIG. 5, the index table 30 is composed by a data format field 301, a name field of display unit 302, and a storage location field of display unit 303. When an end user provides a piece of information inside the storage device 35, the detecting unit 40 compares the data format field 301 of the index table 30 with the format of the stored information so as to get the information of the name field of corresponding display unit 302 and then the displaying programs of the storage location field of display unit 303 are executed to display the information in the storage device 35. For example, when end users provide an audio data into the storage device 35, the detecting unit 40 automatically compares the audio data with the data format field 301 of the index table 30 so as to get the information of the corresponding name field of display unit 302 as well as execute the displaying programs on the storage location field of display unit 303 of the index table 30 for displaying the information in the storage device 35. For example, when an end user provides the storage device 35 with a piece of audio information, the detecting unit 40 automatically compares the information of the audio information with the data format field 301 of the index table 30 so as to obtain the name of the audio display program corresponding to the audio information. By providing the location of the audio display program, the audio display program is executed to display the audio information. When end users provide other digital information, the comparing procedures are similar to that of the audio information.

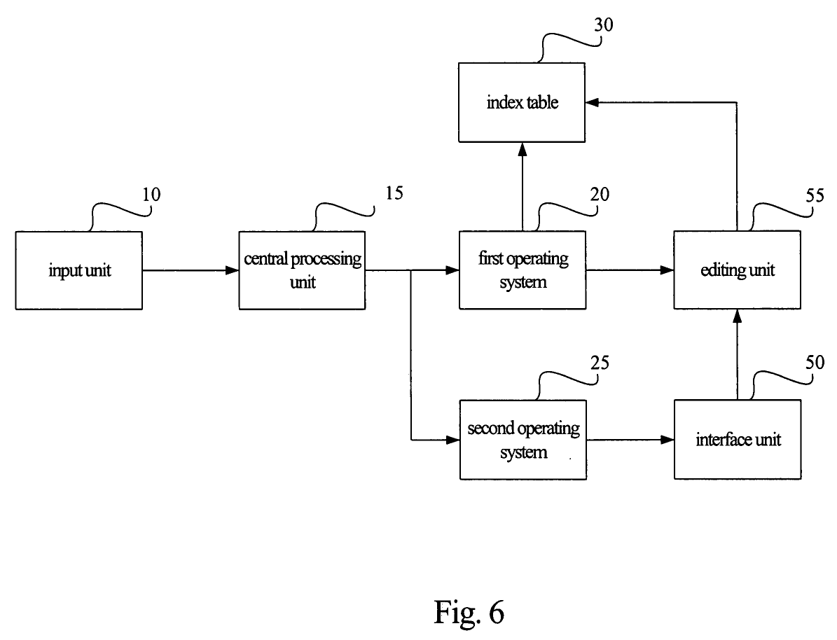

Refer to FIG. 6, a block diagram of a further embodiment in accordance with the present invention is disclosed. An end user sends a startup command to a central processing unit 15 for initiating a second operating system 25. The second operating system 25 shares information of an index table 30 of the first operating system 20 with the first operating system 20. When the end user wants to change the display unit 45 corresponding to the information format recorded by the index table 30, the second operating system 25 converts an editing unit 55 into executable format thereof through an interface unit 50. Thus the end user can use the editing unit 55 to replace the display unit 45, corresponding to the information format recorded by the index table 30.

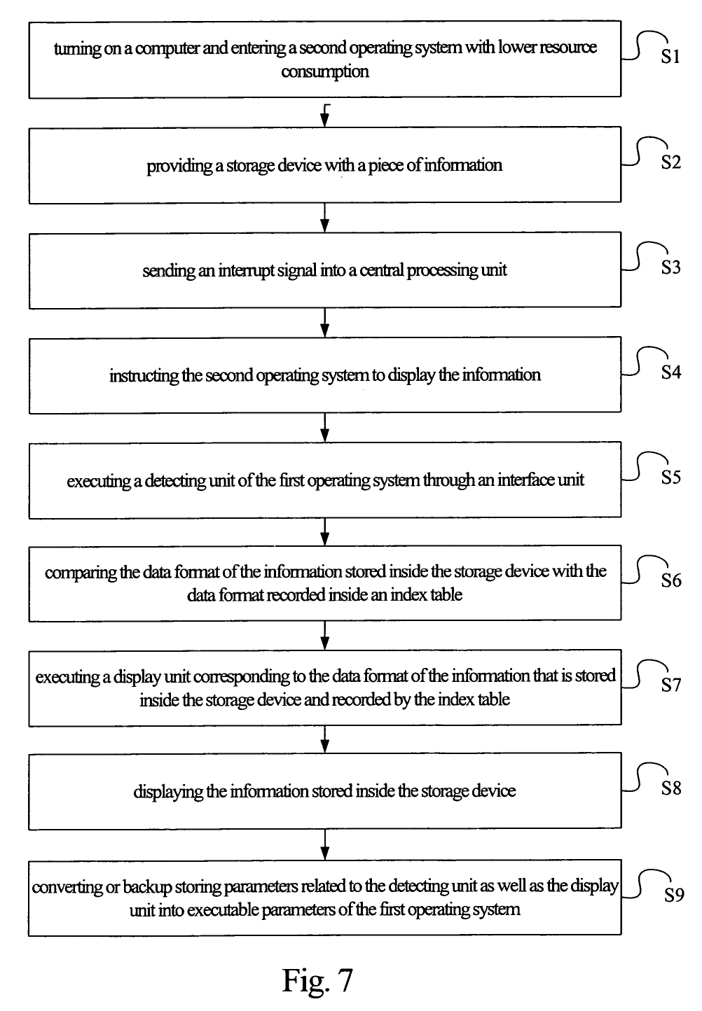

Refer to FIG. 7, a method for auto-display of the storage device comprising the following steps:
Step S1: turning on a computer and entering a second operating system with lower resource consumption;
Step S2: providing a storage device with a piece of information;
Step S3: sending an interrupt signal into a central processing unit through a disk controller connected with the storage device;
Step S4: after receiving the signal, the central processing unit instructing the second operating system to display the information;
Step S5: the second operating system executing a detecting unit of the first operating system through an interface unit;
step S6: comparing the data format of the information stored inside the storage device with the data format recorded inside an index table;
step S7: according to the comparison result, the second operating system executing a display unit corresponding to the data format of the information that is stored inside the storage device and recorded by the index table and;
step S8: displaying the information stored inside the storage device; and
step S9: after displaying the information, converting or backup storing parameters related to the detecting unit as well as the display unit into executable parameters of the first operating system.

In summary, the present invention discloses an auto-display architecture for storage device and method thereof. The architecture consists of a first operating system installed in a larger storage space; a second operating system installed in a smaller storage space so that the portability of the second operating system is raised. When an end user provides a piece of information into a storage device, a disk controller of the storage device sends an interrupt signal to a central processing unit immediately. Then the central processing unit instructs the second operating system to display the information. Through an interface unit, the second operating system converts a detecting unit of the first operating system into an executable format of the second operating system. The detecting unit compares the information format of the information stored in the storage device with the information format recorded inside an index table so as to get a display unit corresponding to the stored information. If the display unit is installed in the first operating system, it is converted into an executable format of the second operating system by the interface unit for displaying the information stored in the storage device. The present invention detects the information stored in the storage device automatically and records information format of the stored information as well as the display unit corresponding to the stored information so as to display the information. Thus end user operate the device easily without going through complicated procedures for displaying information inside the storage device. Moreover, by sharing application programs with the first operating system, the initiating time of the first operating system with higher resource consumption and larger storage space is reduced, the repeated installation of application programs is avoided and the storage space is saved effectively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. An auto-display architecture for storage device comprising:
a first operating system;
a second operating system; and
an index table stored in a file system of the first operating system for recording at least one display unit corresponding to at least an information format;
wherein the second operating system shares information inside the index table of the first operating system with the first operating system.

2. The auto-display architecture for storage device as claimed in claim 1, wherein it further having an editing unit that is executed under the first operating system for providing editing operation of the display unit corresponding to the information format that is recorded by the index table.

3. The auto-display architecture for storage device as claimed in claim 2, wherein the second operating system shares the editing unit through an interface unit.

4. The auto-display architecture for storage device as claimed in claim 1, wherein system resource consumption of the first operating system is larger than system resource consumption of the second operating system.

5. An auto-display method for storage device comprising the steps of:
providing a first operating system and a second operating system; and
storing an index table to a file system of the first operating system for recording at least one display unit corresponding to at least one information format;
wherein the second operating system shares information inside the index table of the first operating system with the first operating system.

6. The method as claimed in claim 5, wherein after step of storing the index table to the file system, the second operating system executes an editing unit of the first operating system through an interface unit for editing operation of the display unit corresponding to the information format that is recorded by the index table.

7. The method as claimed in claim 5, wherein system resource consumption of the first operating system is larger than system resource consumption of the second operating system.

8. An auto-display architecture for storage device comprising:
a first operating system;
a second operating system;
a storage device for storing at least one piece of information;
an index table saved in a file system of the first operating system for recording at least one display unit corresponding to at least one information format; and
a detecting unit being executed under the first operating system for comparing information format of the information stored in the storage device with information in the index table;
wherein the second operating system executes the detecting unit through an interface unit and then runs the display unit corresponding to the stored information that is recorded by the index table to display the information stored in the storage device according to the comparison result.

9. The auto-display architecture for storage device as claimed in claim 8, wherein it further having a disk control unit coupled with the storage device for producing an interrupt signal of input/output access of the storage device.

10. The auto-display architecture for storage device as claimed in claim 9, wherein it further having a central processing unit for receiving the interrupt signal produced by the disk control unit.

11. The auto-display architecture for storage device as claimed in claim 8, wherein the display unit is executed under the first operating system while the second operating system executes the display unit through the interface unit to display the information stored in the storage device.

12. The auto-display architecture for storage device as claimed in claim 8, wherein the storage device is an external storage device.

13. The auto-display architecture for storage device as claimed in claim 12, wherein the external storage device is a hard disk with a Universal Serial Bus (USB) interface.

14. An auto-display method for storage device comprising the steps of:
providing a first operating system and a second operating system;
providing a storage device for storing at least one piece of information;
storing an index table into a file system of the first operating system for recording at least a display unit corresponding to at least one information format;
providing a detecting unit under the first operating system for comparing the information format of the information stored in the storage device with the information in the index table;
wherein the second operating system executes the detecting unit through an interface unit and then runs the display unit corresponding to the stored information that is recorded by the index table to display the information stored in the storage device according to the comparison result.

15. The method as claimed in claim 14, wherein after step of providing a storage device, providing a disk control unit coupled with the storage device for producing an interrupt signal of input/output access of the storage device.

16. The method as claimed in claim 15, wherein after step of producing an interrupt signal by the disk control unit, providing a central processing unit for receiving the interrupt signal produced by the disk control unit.

17. The method as claimed in claim 14, wherein the second operating system executes the display unit through the interface unit to display the information stored in the storage device when the display unit is installed in the first operating system.

18. An auto-display architecture for storage device comprising:
a first operating system;
a second operating system;
a storage device for storing at least one piece of information;
an index table stored in a file system of the first operating system for recording at least one display unit corresponding to at least one information format; and
a detecting unit being executed under the second operating system for comparing information format of the information stored in the storage device with information in the index table;
wherein the second operating system executes the display unit corresponding to the information stored in the storage device to display the information stored in the storage device according to the comparison result of the detecting unit.

19. The auto-display architecture for storage device as claimed in claim 18, wherein it further having a disk control unit coupled with the storage device for producing an interrupt signal of input/output access of the storage device.

20. The auto-display architecture for storage device as claimed in claim 19, wherein it further having a processing unit for receiving the interrupt signal produced by the disk control unit.

21. The auto-display architecture for storage device as claimed in claim 18, wherein the display unit is executed under the first operating system while the second operating system executes the display unit through an interface unit to display the information stored in the storage device.

22. An auto-display method for storage device comprising the steps of:
providing a first operating system and a second operating system;
providing a storage device for storing at least one piece of information;
storing an index table into a file system of the first operating system for recording at least one display unit corresponding to at least one information format; and
providing a detecting unit under the second operating system for comparing the information format of the information stored in the storage device with the information in the index table;
wherein the second operating system executes the display unit corresponding to the stored information that is recorded by the index table to display the information stored in the storage device according to the comparison result of the detecting unit

23. The method as claimed in claim 22, wherein after step of providing a storage device, providing a disk control unit coupled with the storage device for producing an interrupt signal of input/output access of the storage device.

24. The method as claimed in claim 23, wherein after step of producing an interrupt signal by the disk control unit, providing a central processing unit for receiving the interrupt signal produced by the disk control unit.

25. The method as claimed in claim 22, wherein the second operating system executes the display unit through an interface unit to display the information stored in the storage device when the display unit is installed in the first operating system.
